(19) United States
(12) Patent Application Publication
(10) Pub. No.: US 2015/0077872 A1
(43) Pub. Date: Mar. 19, 2015

(54) DEVICE INTEGRATING REARVIEW MIRROR AND DRIVING RECORDER SCREEN

(71) Applicants: GEORGE TANG INDUSTRIAL CORP., Miaoli (TW); IVS, INC., Newton, AL (US)

(72) Inventors: RICHIE HOWARD, NEWTON, AL (US); GEORGE TANG, MIAOLI (TW)

(73) Assignees: GEORGE TANG INDUSTRIAL CORP., Miaoli (TW); IVS, INC., Newton, AL (US)

(21) Appl. No.: 14/028,660

(22) Filed: Sep. 17, 2013

(51) Int. Cl. B60R 1/12

(52) U.S. Cl. CPC B60R 1/12; B60R 2001/1253
USPC 359/844

(57) ABSTRACT

The present invention discloses a device integrating a rearview mirror and a driving recorder screen, which comprises a rearview mirror baseplate having at one rotary shaft on one lateral thereof; a mirror installed in the rearview mirror baseplate; and a driving recorder screen having at least one pivotal coupling member on one lateral thereof. The rotary shaft is coupled to the pivotal coupling member. Thereby, the driving recorder screen is integrated with the rearview mirror baseplate. Thus, the driver can watch the mirror and the driving recorder screen simultaneously, neither distracted nor fatigued. Therefore, the present invention not only can increase convenience of drivers but also can improve safety of driving.

### BACKGROUND OF THE INVENTION

1. Field of the Invention

The present invention relates to a driving recorder screen, particularly to a device integrating a rearview mirror and a driving recorder screen.

2. Description of the Related Art

More and more traffic problems, such as traffic accidents, traffic violations and traffic disputes, occur with automobiles becoming indispensable traffic instruments of modem people. While a traffic accident, violation or dispute occurs, the course of events and the attribution of responsibility are determined according to the investigation by the authorities concerned and the statements by the persons involved traditionally. However, the driving recorder has become an additional powerful tool in dealing with traffic problems now.

The location where the user mounts the screen of his driving recorder greatly influences the driving behavior of the user. The driving recorder screens available in the market are normally fabricated according to the designs of the manufacturers. The user has to mount his driving recorder screen in a specified location of his automobile. As long as the driving recorder screen has been mounted, it cannot be adjusted any more. Thus, the application thereof is limited.

In other words, the manner of using a driving recorder screen varies with the location and orientation of the driving recorder screen and the style of the automobile. No matter where the fixed type driving recorder screen is installed, the driver has to split his attention to the road status and the screen. In other words, the driver's mind fluctuates back and forth between the road status and the screen very frequently. It not only fatigues the driver but also may cause danger. Therefore, the conventional driving recorder screens can not meet requirement of drivers.

The Inventors undertook a great deal of analysis and research on the abovementioned problems and finally developed a device integrating a rearview mirror and a driving recorder screen to solve the abovementioned problems.

### SUMMARY OF THE INVENTION

The primary objective of the present invention is to provide a device integrating a rearview mirror and a driving recorder screen, which comprises a rearview mirror baseplate having at one rotary shaft on one lateral thereof; and a driving recorder screen having at least one pivotal coupling member on one lateral thereof, wherein the rotary shaft is coupled to the pivotal coupling member, whereby the driving recorder screen is integrated with the rearview mirror baseplate, wherefore the driver can watch the mirror and the driving recorder screen simultaneously, neither distracted nor fatigued, and wherefore driving safety is improved.

Another objective of the present invention is to provide a device integrating a rearview mirror and a driving recorder screen, whereby the driver can use the mechanism of the rotary shaft and the pivotal coupling member to adjust the driving recorder screen to obtain an optimized viewing angle, wherefore driver's convenience is improved.

To achieve the above mentioned objectives, the present invention proposes a device integrating a rearview mirror and a driving recorder screen, which comprises a rearview mirror baseplate having at one rotary shaft on one lateral thereof; a mirror installed in the rearview mirror baseplate; and a driving recorder screen having at least one pivotal coupling member on one lateral thereof, wherein the rotary shaft is coupled to the pivotal coupling member.

Below, the embodiments are described in detail in cooperation with the attached drawings to make easily understood the objectives, technical contents, characteristics and accomplishments of the present invention.

### BRIEF DESCRIPTION OF THE DRAWINGS

FIG. 1 is a perspective view schematically showing a device integrating a rearview mirror and a driving recorder screen according to one embodiment of the present invention;

FIG. 2 is an exploded view schematically showing a device integrating a rearview mirror and a driving recorder screen according to one embodiment of the present invention;

FIG. 3 is a top view schematically showing a device integrating a rearview mirror and a driving recorder screen according to one embodiment of the present invention;

FIG. 4 is a top view schematically showing the application of a device integrating a mirror and a driving recorder screen according to one embodiment of the present invention;

FIG. 5 is a perspective view schematically showing a device integrating a rearview mirror and a driving recorder screen and including a first bayonet according to one embodiment of the present invention;

FIG. 6 is a perspective view and an exploded view schematically showing a device integrating a rearview mirror and a driving recorder screen including a second bayonet according to one embodiment of the present invention; and

FIG. 7 is an exploded view schematically showing a device integrating a rearview mirror and a driving recorder screen and including a second bayonet according to one embodiment of the present invention.

### DETAILED DESCRIPTION OF THE INVENTION

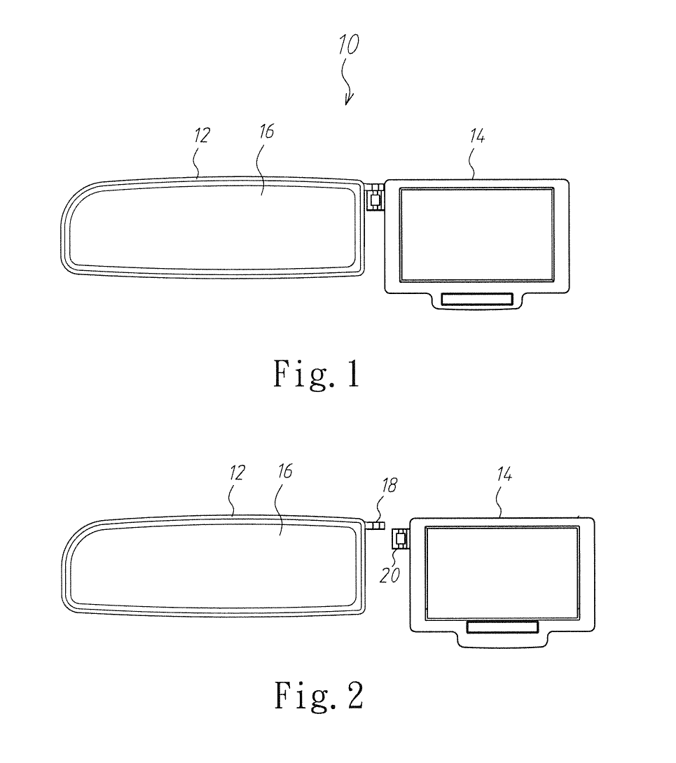

Refer to FIG. 1 and FIG. 2 respectively a perspective view and an exploded view schematically showing a device integrating a rearview mirror and a driving recorder screen according to one embodiment of the present invention. The “device integrating a rearview mirror and a driving recorder screen” 10 of the present invention comprises a rearview mirror baseplate 12 and a driving recorder screen 14. A mirror 16 is installed in the rearview mirror baseplate 12, reflecting the images of the rear side. As shown in FIG. 2, the rearview mirror baseplate 12 has at least one first rotary shaft 18 on one lateral thereof, and the driving recorder screen 14 has at least one first pivotal coupling member 20 on one lateral thereof. The first rotary shaft 18 can be coupled to the first pivotal coupling member 20.

The automobile manufacturers normally fix the rearview mirror baseplate 12 to the vehicle upper/center windshield of the automobile. In the present invention, the rearview mirror baseplate 12 and the driving recorder screen 14 respectively have at least one first rotary shaft 18 and at least one first pivotal coupling member 20 on the laterals thereof, and the first rotary shaft 18 is couple to the first pivotal coupling member 20. Thereby, the driving recorder screen 14 is integrated with the rearview mirror baseplate 12. Therefore, the driver can watch the mirror 16 and the driving recorder screen 14 simultaneously without distraction, and the driver is less likely to fatigue even in long time driving. Thus, driving safety is improved.

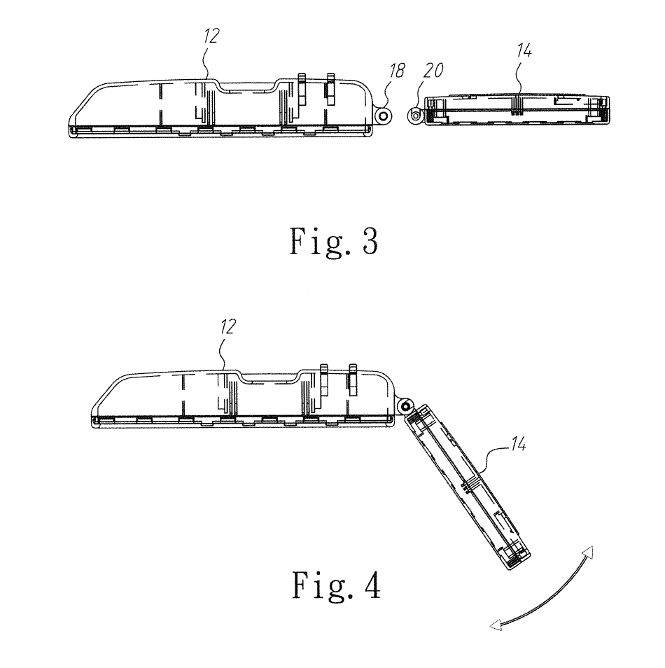

Refer to FIG. 3 and FIG. 4. FIG. 3 is a top view schematically showing a device integrating a rearview mirror and a driving recorder screen according to one embodiment of the present invention. FIG. 4 is a top view schematically showing the application of a device integrating a mirror and a driving recorder screen according to one embodiment of the present invention. Via the pivotally coupled first rotary shaft 18 and first pivotal coupling member 20, the driver can conveniently adjust the driving recorder screen 14 to obtain an optimized viewing angle.

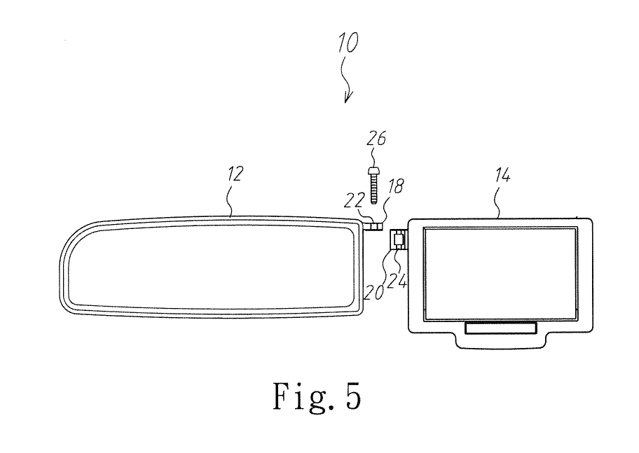

The embodiments described above are only to exemplify the present invention but not to limit the scope of the present invention. Refer to FIG. 5 schematically showing a device integrating a rearview mirror and a driving recorder screen and including a first bayonet according to one embodiment of the present invention. In the embodiment shown in FIG. 5, the first rotary shaft 18 has a first through-hole 22; the first pivotal coupling member 20 has a second through-hole 24; the device further comprises at least one first bayonet 26. The first bayonet 26 is inserted through the first through-hole 22 and the second through-hole 24, securely pivotally coupling of the first rotary shaft 18 to the first pivotal coupling member 20. Via the mechanism of the first rotary shaft 18, the first pivotal coupling member 20 and the first bayonet 26, the driver can conveniently adjust the driving recorder screen 14 to obtain an optimized viewing angle.

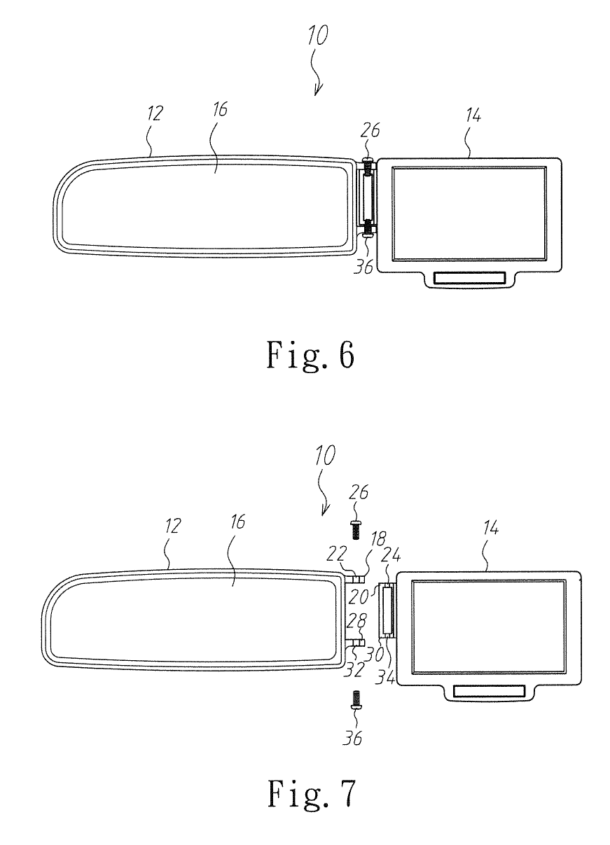

The aforementioned embodiments have been described in detail in cooperation with the drawings to fully disclose the present invention so that the persons skilled in the art can understand, make and use the present invention according to the specification. However, it should be noted that these embodiments are only to exemplify the present invention but not to limit the scope of the present invention. The embodiment shown in FIG. 5 only has one first bayonet 26 inserted through the first through-hole 22 and the second through-hole 24. Refer to FIG. 6 and FIG. 7 for a further embodiment. FIG. 6 and FIG. 7 respectively a perspective view and an exploded view schematically showing a device integrating a rearview mirror and a driving recorder screen and including a second bayonet according to one embodiment of the present invention. In the embodiment shown in FIG. 6 and FIG. 7, the rearview mirror baseplate 12 further has at least one second rotary shaft 28, and the driving recorder screen 14 has at least one second pivotal coupling member 30, in addition to the first through-hole 22, the second through-hole 24 and the first bayonet 26. In the embodiment shown in FIG. 6 and FIG. 7, the second rotary shaft 28 has a third through-hole 32; the second pivotal coupling member 30 has a fourth through-hole 34; the device further comprises at least one second bayonet 36. The second bayonet 36 is inserted through the third through-hole 32 and the fourth through-hole 34. Via the first bayonet 26 and the second bayonet 36, the first rotary shaft 18 is pivotally coupled to the first pivotal coupling member 20 more securely, and the second rotary shaft 28 is pivotally coupled to the second pivotal coupling member 30 more securely.

While a plurality of rotary shafts and a plurality of pivotal coupling members are used, the number of the first rotary shafts 18 is equal to the number of the second rotary shafts 28, and the number of the first pivotal coupling members 20 is equal to the number of the second pivotal coupling members 30. While the first bayonets 26 and the second bayonets 36 are used, each of the numbers of the first bayonets 26 and the second bayonets 36 is equal to the number of the first the first rotary shafts 18, the first pivotal coupling members 20, the second rotary shafts 28 or the second pivotal coupling members 30.

In one embodiment of the “device integrating a rearview mirror and a driving recorder screen” 10 of the present invention, the first bayonet 26 has a male screw thread, and the first through-hole 22 and the second through-hole 24 respectively have female screw threads. The male screw thread of the first bayonet 26 can be screwed into and tightly engaged with the female screw threads of the first through-hole 22 and the second through-hole 24. The second bayonet 36, the third through-hole 32 and the fourth through-hole 34 are also realized in the same way, and the detail thereof will not repeat herein.

In conclusion, the present invention discloses a “device integrating a rearview mirror and a driving recorder screen” 10, which comprises a rearview mirror baseplate 12 and a driving recorder screen 14, wherein the rearview mirror baseplate 12 has at least one first rotary shaft 18 on one lateral thereof, and the driving recorder screen 14 has at least one first pivotal coupling member 20 on one lateral thereof, and wherein the first rotary shaft 18 is coupled to the first pivotal coupling member 20, whereby the driving recorder screen 14 is integrated with the rearview mirror baseplate 12. Via the pivotal coupling of the first rotary shaft 18 and the first pivotal coupling member 20, the driver can conveniently adjust the driving recorder screen 14 to obtain an optimized viewing angle. Further, the driver can watch the mirror 16 and the driving recorder screen 14 simultaneously, neither distracted nor fatigued. Therefore, the present invention not only can increase convenience of drivers but also can improve safety of driving.

The embodiments of the present invention have been described in detail to demonstrate the technical contents and characteristics of the present invention and enable the persons skilled in the art to understand, make, and use the present invention. However, these embodiments are not intended to limit the scope of the present invention. Any equivalent modification or variation according to the structure, characteristic or spirit of the present invention is to be also included within the scope of the present invention.

What is claimed is:

1. A device integrating a rearview mirror and a driving recorder screen, comprising
a rearview mirror baseplate having at one rotary shaft on one lateral thereof;
a mirror installed in said rearview mirror baseplate; and
a driving recorder screen having at least one pivotal coupling member on one lateral thereof, wherein said rotary shaft is coupled to said pivotal coupling member.

2. The device integrating a rearview mirror and a driving recorder screen according to claim 1, wherein said driving recorder screen can be adjusted to obtain an optimized viewing angle via a mechanism of said rotary shaft and said pivotal coupling member.

3. The device integrating a rearview mirror and a driving recorder screen according to claim 1, wherein said rotary shaft has a first through-hole, and said pivotal coupling member has a second through-hole, and wherein at least one bayonet is inserted through said first through-hole and said second through-hole.

4. The device integrating a rearview mirror and a driving recorder screen according to claim 3, wherein said driving recorder screen can be adjusted to obtain an optimized viewing angle via a mechanism of said rotary shaft, said pivotal coupling member and said bayonet.

5. The device integrating a rearview mirror and a driving recorder screen according to claim 3, wherein a plurality of said rotary shafts and a plurality of said pivotal coupling members are used, and wherein said rotary shafts and said pivotal coupling members are identical in quantity.

6. The device integrating a rearview mirror and a driving recorder screen according to claim 4, wherein said bayonet has a male screw thread, and wherein each of said first through-hole and said second through-hole has a female screw thread, and wherein said male screw thread of said bayonet can be screwed into said female screw threads of said first through-hole and said second through-hole tightly.

7. The device integrating a rearview mirror and a driving recorder screen according to claim 3, wherein a plurality of said rotary shafts, a plurality of said pivotal coupling members and a plurality of said bayonets are used, and wherein said rotary shafts, said pivotal coupling members and said bayonets are identical in quantity.

8. The device integrating a rearview mirror and a driving recorder screen according to claim 1, wherein said mirror can reflect images of a rear side.
